(19) United States
(12) Patent Application Publication
(10) Pub. No.: US 2003/0152835 A1
(43) Pub. Date: Aug. 14, 2003

(54) Carbon fibre containing negative electrode for lithium battery

(76) Inventors: Sankar Dasgupta, Missisauga (CA); Rakesh Bhola, Toronto (CA); James K. Jacobs, Toronto (CA)

Correspondence Address: Gowling Lafleur Henderson LLP, Suite 4900, Commerce Court West, Toronto, ON, M5L 1J3, CA

(21) Appl. No.: 10/067,905

(22) Filed: Feb. 8, 2002

(51) Int. Cl. H01M 4/62; H01M 4/58

(52) U.S. Cl. 429/232; 429/212; 429/231.8

(57) ABSTRACT

The invention basically comprises the addition of a small amount of nanometer sized carbon tubes or fibres grown by high temperature vapour deposition to a meso-phase graphite mixture used for a negative electrode (anode) for a lithium battery. These are referred to herein as “carbon nano-fibres”. According to one embodiment of the present invention, in an anode for a lithium battery having a conductive substrate coated with a pressed compact of spherical graphite and an ion-conducting polymeric binder, an amount of from 1.5 to 15% by weight of carbon nano-fibres is added. The carbon nano-fibres may have an average diameter of around 0.2 mm (200×10−9 m) a length of from 10 to 20 mm and an inner core diameter of from 65-70 nm. The spherical graphite may be mesophase graphite and more preferably, the carbon nano-fibres are included in amount of from 2 to 9% by weight.

### FIELD OF THE INVENTION

This invention relates to electrode structures for lithium batteries and more specifically to carbon-based substrates used in anodes for such batteries.

### BACKGROUND OF THE INVENTION

Although an anode for a lithium battery can be elemental lithium, current practice is favouring the use of a material capable of intercalating elemental lithium in its inert structure, such as graphite. The anode material is coated on metal foil, normally copper, which acts as a current collector, is placed in the proximity of a cathode and the electrodes are separated by some form of electrolyte. The cathode is typically a transition metal oxide mixed with fine carbon particles and a binder.

A separator layer of an inert polymer permeable to lithium ions or lithium ions containing non-aqueous liquids is placed between the anode and the cathode to prevent their physical contact. The assemblies are soaked or wetted by a lithium ion containing organic liquid electrolyte, such as LiPF₆ in di-methyl or methylethyl carbonate, and sealed in plastic wrapping to prevent moisture entering the lithium electrochemical cell. The electrolyte may also be a solid, lithium ion conducting polymer layer.

For the carbon particles to intercalate reversibly lithium ions from the electrolyte solution, the carbon must have a particular lattice spacing and be exposed to the electrolyte solution. Graphitic carbon satisfies the lattice spacing requirement, but in its pure form generally will not achieve its theoretical capacity to intercalate lithium ions. It is believed that one cause of this might be the plate-like nature of pure graphite causing bridging and resulting in closed voids which are inaccessible to the electrolyte solution.

Much better results in terms of charge capacity have been observed with the use of what is referred to as “meso-phase” graphite in the anode composition for rechargeable lithium ion batteries. It is believed that as meso-phase graphites are less plate-like and more spheroidal than elemental graphite, they are less prone to forming inaccessible voids than the latter.

Despite advances in rechargeable lithium ion battery technology, there remains a need for such batteries which are better suited to pulsed current demands and improved cycle life capacity. The cycle life capacity is basically a measure of the battery's capacity after charging for repeated charge/discharge cycles. Typically, the capacity diminishes with each charging until a point is reached where the amount of charge becomes insufficient for the battery to provide current for a desired period of time. Presumably the decay in capacity is a reflection of an inability of the graphite to intercalate as many lithium ions as in previous charges. This may be due to breakdown products of the electrolyte blocking or deactivating the active sites of the graphite or to similar disadvantageous side reactions.

For the sake of clarity, it should be pointed out that it is known to add carbon particles to augment electrical conduction in the cathode or positive electrode. The cathode is usually made of particles of a lithium containing transition metal oxide or sulphide compound, incorporating fine, non-crystalline, conductive, carbon particles. Such carbon particles would typically be smaller particles or non-crystalline fibres. The cathode however contains on an amorphous carbon structure which is not capable of intercalating lithium. The present invention involves, as discussed in more detail below the addition of nanometer sized carbon tubes or fibres to the anode in order to enhance cycle life and rate capacity, particularly for pulsed current.

It should further be pointed out that it is known to manufacture the anode of a lithium battery entirely from a carbon fibre or nano-fibre material as evidenced by U.S. Pat. No. 5,879,836 (Ikeda et al.) and U.S. Pat. No. 5,856,043 (Ohsaki et al.). The teachings of the foregoing patents are distinguishable from the present invention in that the anode structure of the present invention is substantially of a pressed compact spherical graphite containing less than 15% by weight of carbon nano-fibres in the pressed compact.

Additionally, U.S. Pat. No. 5,512,393 (Harada et al.) teaches the use of vapour-grown and graphitized non-tubular carbon fibres in an anode however such is used for the entire carbon component of the anode. Furthermore, the dimensions of the fibres are of micron rather than of nanometer size.

The foregoing references teach carbon fibres or nano-fibres as an alternative to conventional spherical graphite anodes and make no suggestion as to how a relatively small addition of carbon nano-fibres may greatly enhance the performance characteristics of an anode which is principally of spherical graphite powder.

### SUMMARY OF THE INVENTION

The invention basically comprises the addition of a small amount of nanometer sized carbon tubes or fibres grown by high temperature vapour deposition, to a graphite mixture such as a spherical graphite containing mixture, used for a negative electrode (anode) for a lithium battery. These are referred to herein as “carbon nano-fibres”.

According to the present invention, in an anode for a lithium battery having a conductive substrate coated with a pressed compact of spherical graphite and an ion-conducting polymeric binder, an amount of from 1.5 to 15% by weight of carbon nano-fibres is added.

The carbon nano-fibres may have an average diameter of around 0.2 μm (200×10⁻⁹ m), length of from 10 to 20 μm and, inner core diameter of from 5080 nm. This corresponds to an aspect ratio of from 50 to 100. The spherical graphite may be meso-phase graphite and more preferably, the carbon nano-fibres are included in amount of from 2 to 9% by weight.

The nano-fibres may be subject to vacuum at a heat treating temperature prior to or after mixing with the spherical graphite.

According to one embodiment of the present invention, the nano-fibres may be heat and vacuum treated prior to mixing with the meso-phase carbon, in which case the heat treating temperature may be from 40° C. to 140° C.

According to another embodiment of the invention, the heat and vacuum treating may be carried out after preparation of the mixture of carbon fibres, mesophase carbon particles, ionic binder and wetting of the mixture with lithium ion containing solution. According to this embodiment, the heat treating temperature may be from 45° C. to 80° C.

The vacuum may be less than 10 torr.

The duration of heat and vacuum treatment may be from 2 to 8 hours.

### DESCRIPTION OF DRAWINGS

Preferred embodiments of the present invention are described below with reference to the accompanying drawings in which:

FIG. 1 is a scanning electron micrograph (“SEM”) picture of vapour grown carbon fibres of the type used in the present invention;

FIG. 2 is a scanning electron micrograph picture corresponding to FIG. 1 but at a different magnification; and,

FIG. 3 is a graph illustrating the improved cycle-life of a rechargeable lithium battery made in accordance with the present invention.

### DETAILED DESCRIPTION OF THE INVENTION

According to the present invention, a negative electrode (anode) for a lithium battery is produced by combining a mixture of approximately 95% by weight graphite and 5% by weight ion-conducting polymeric binder to form a coating which is subsequently applied to a current collector, such as copper foil. The graphite is preferably a spherical graphite such as mesocarbon microbeads to which an amount of about 1.5% to about 15% of carbon nano-fibres has been added. The graphite/binder mixture is compressed into a pressed compact with copper foil on one side and a suitable separator on the other side. The separator, as described in the background above is preferably an inert polymer permeable to lithium ions or lithium ion containing non-aqueous liquids.

Suitable results have been obtained using commercially available carbon nano-fibres, such as for example, VGCF-G (Vapour Grown Carbon Fibres) marketed by the Showa Denko Company, which are pretreated nanometer-sized carbon tubes or fibres grown by high temperature vapour deposition. Such have an average diameter of the order of 200 nm (0.2 μm or 200×10⁻⁹ m), an elongated structure with an average length of from 10 to 20 μm and an inner core diameter of from 65-70 nm.

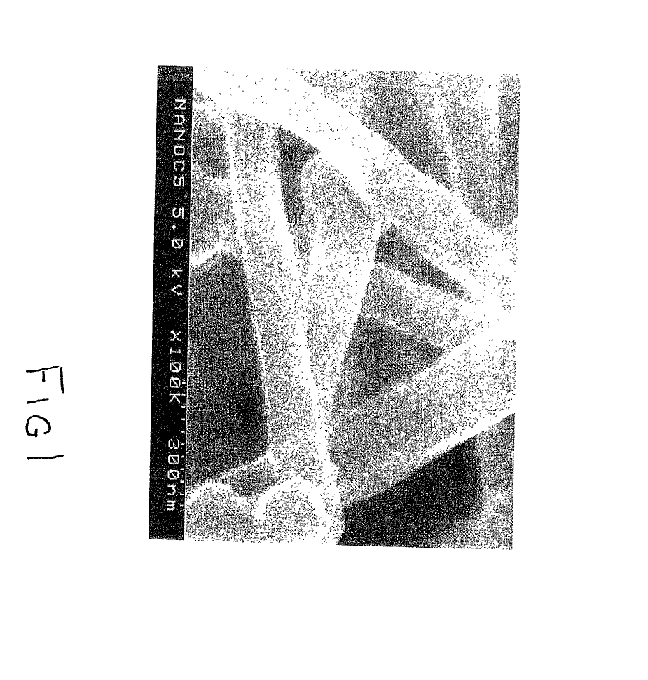

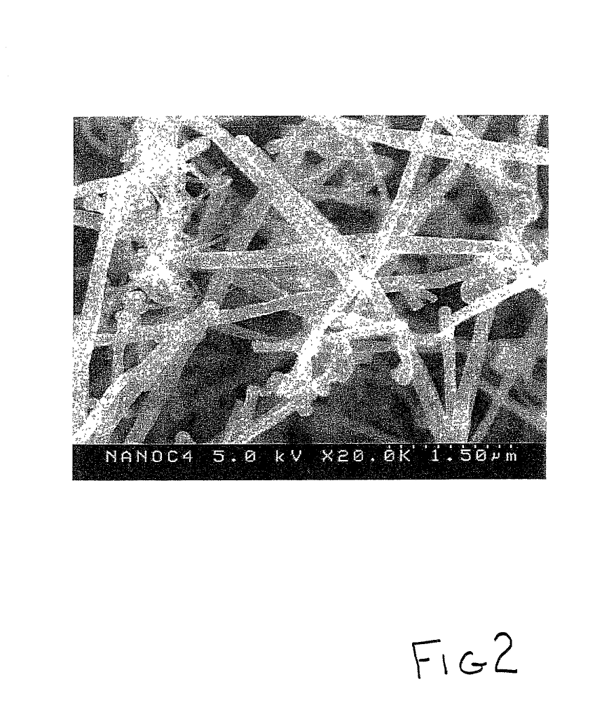

FIGS. 1 and 2 are SEM (scanning electron micrograph) pictures of typical vapour grown carbon fibres. FIG. 1 indicates 0.3 μm (300 nm) scale. FIG. 2 indicates a 1.5 μm scale.

In the preferred embodiment, the carbon nano-fibres are treated in vacuum at temperatures above 40° C. and mixed with commercially available graphitic mesophase carbon micro-balls (MCMB) and binders in a conventional manner. The preferred amount of carbon nano-fibres in the anode mixture ranges between 1.5-15% by weight, the more preferred amount being 2-9% by weight. Cost considerations currently favour a range of between 2-2.5% by weight on account of what is presently a very high cost of this material.

Use of the above mixture in an anode for a lithium battery has been found to yield an initial impedence similar to that without the addition of the carbon nano-fibres, however drastic cycle life increases are possible. Furthermore rate capacity, particularly for pulsed current, is much better. It has further been found that if the carbon nano-fibres are heated in a partial vacuum at heat treatment temperatures of from 40° C. to 140° C., prior to mixing with the graphitic MCMB for from 2 to 8 hours (depending on the selected temperature of the treatment), further significant cycle life increases are obtainable. The vacuum applied may be less than about 10 torr and preferably about 1 torr (1 mm of Hg).

Alternatively, the graphitic MCMB and ionic binder may be premixed and wetted with the lithium ion containing electrolyte solution, and subsequently heat and vacuum treated. In this case, the maximum heat treatment temperature should not exceed 80° C. in order to avoid damage to any organic constituents and the present preferred range is from 45° C. to 80° C. The duration of treatment may be from 2 to 8 hours depending on the selected temperature of the treatment.

The invention is further illustrated by reference to the examples below.

### EXAMPLE 1

Nano-sized carbon fibrils, marketed as VGCF-G by the Showa Denko Company, were heated in a vacuum for 3 hours at 125° C., and subsequently allowed to cool in vacuum. The treated nano-carbon fibrils were added to commercially available graphitic mesophase carbon micro-balls (MCMB) in 2.5 wt. % and additionally mixed with an ionically conductive polyvinylidene fluoride binder, marketed under the trade-name of Kynar, in 5 wt %. The mixture obtained was spread over copper foil in 200 μm thickness for use as negative electrode (anode) in a rechargeable lithium electrochemical cell. The lithium electrochemical cell having the above anode, further included a microporous polyethylene separator marketed by the Tonen Co. under the name of ‘Setella’, and a cathode or positive electrode, containing lithium-maganese oxide particles carried on an aluminum foil current collector. The assembled electrochemical cell was subsequently impregnated with ethylene carbonate-dimethyl carbonate electrolyte containing LiPF₆ in 1 M concentration, and sealed in a multi-layered protective polymer wrapping in the usual manner.

### EXAMPLE 2

Nano-sized carbon fibrils, marketed as VGCF-G by the Showa Denko Company, were added to commercially available graphitic mesophase carbon micro-balls (MCMB) in 3 wt % and additionally mixed with an ionically conductive polyvinylidene fluoride binder, marketed under the trade name of Kynar, in 5 wt %. The above mixture was wetted with a small amount of ethylene carbonate-dimethyl carbonate electrolyte containing LiPF₆ in 1 M concentration, and further mixed to yield an anode paste. The obtained paste was subsequently heated in a vacuum of 5 torr for 6 hours at 55° C., and subsequently allowed to cool in vacuum. The mixture obtained was spread over copper foil in 200 μm thickness for use as negative electrode (anode) in a rechargeable lithium electrochemical cell. The lithium electrochemical cell having the above anode additionally included a microporous polyethylene separator marketed by the Tonen Co. under the name of ‘Setella’ and a cathode or positive electrode, containing lithium-maganese oxide particles carried on an aluminum foil current collector. The assembled electrochemical cell was subsequently impregnated with ethylene carbonate-dimethyl carbonate electrolyte containing LiPF₆ in 1 M concentration, and sealed in a multi-layered protective polymer wrapping in the usual manner.

### EXAMPLE 3

Nano-sized carbon fibrils, marketed as VGCF-G by the Showa Denko Company, were added to commercially available graphitic mesophase carbon micro-balls (MCMB) in 3 wt. % and additionally mixed with an ionically conductive polyvinylidene fluoride binder, marketed under the trade name of Kynar, in 5 wt %. The above mixture was wetted with a small amount of ethylene carbonate-dimethyl carbonate electrolyte containing LiPF₆ in 1 M concentration, and further mixed to yield an anode paste. The obtained paste was subsequently heated in a vacuum of 3 torr for 4 hours at 65° C., and subsequently allowed to cool in vacuum. The mixture obtained was spread over copper foil in 200 μm thickness for use as negative electrode (anode) in a rechargeable lithium electrochemical cell. The lithium electrochemical cell having the above anode additionally included a microporous polyethylene separator marketed by the Tonen Co. under the name of ‘Setella’ and a cathode or positive electrode, containing lithium-cobalt oxide particles carried on an aluminum foil current collector. The assembled electrochemical cell was subsequently impregnated with ethylene carbonated/methyl carbonate electrolyte containing LiPF₆ in 1 M concentration, and sealed in a multi-layered protective polymer wrapping in the usual manner.

### EXAMPLE 4

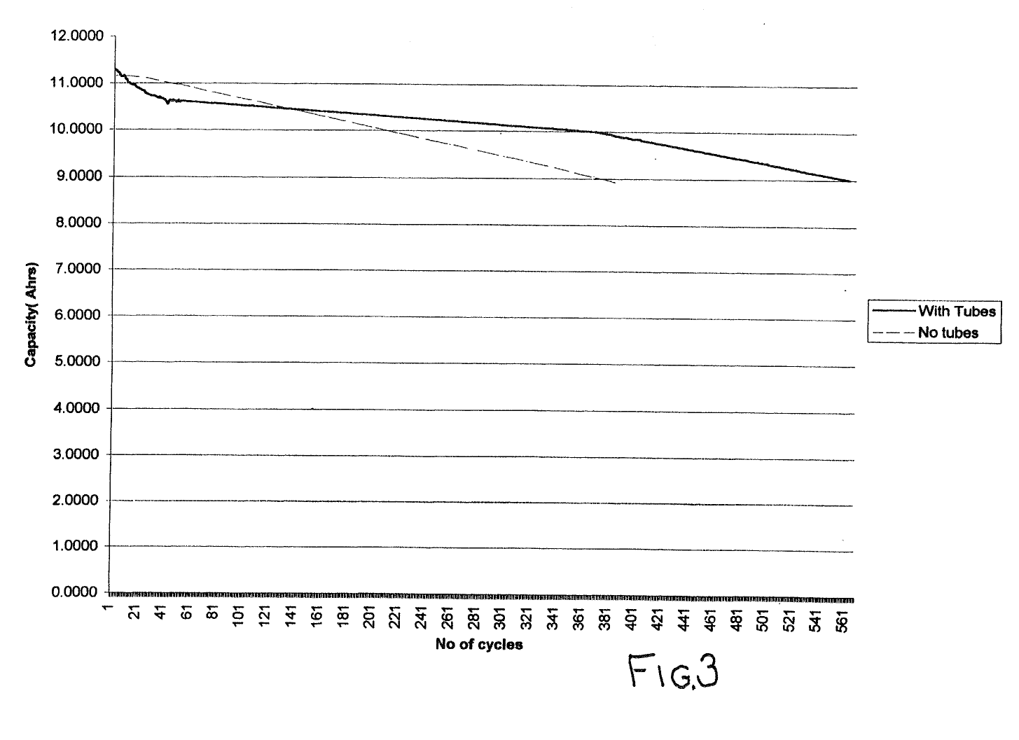

Rechargeable lithium batteries having carbon nano-fibril containing anodes and assembled as described in Example 3 were compared in performance to conventional graphite anode containing rechargeable lithium batteries. The lithium batteries tested were first charged to 4.2 volt at 1.75 ampere current to reach 3.0 volt. The lithium battery capacity in ampere hours (A/hrs) was plotted against the number of charging-discharging cycles attained, and the obtained graph is shown on FIG. 3. It can be seen that the performance of the nano-fibril (nano-tubes) bearing lithium battery notably out-performs the conventionally made lithium battery.

The above description is intended in an illustrative rather than a restrictive sense. Variations to the exact description may be apparent to those skilled in the relevant art without departing from the spirit and scope of the invention as defined by the claims set out below.

1. In an anode for a lithium battery having a conductive substrate coated with a pressed compact of spherical graphite and an ion conducting polymeric binder, the improvement comprising:
the inclusion of up to from 1.5 to 15% by weight of carbon nano-fibres in said pressed compact.

2. The anode of claim 1 wherein:
said spherical graphite is meso-phase carbon micro-balls;
said carbon nano-fibres have an average diameter of about 200 nm, a length of from 10 to 20 μm and an inner core diameter of 65 to 70 nm.

3. The anode of claim 2 wherein:
said carbon nano-fibres are included in an amount of from 2% to 9% by weight.

4. The anode of claim 3 wherein:
said carbon nano-fibres are pretreated vapour grown carbon fibres.

5. The anode of claim 4 wherein:
said nano-fibres were subject to vacuum at a heat treatment temperature of from 40° to 140° C. for a period of from 2 to 8 hours prior to mixing with said spherical graphite.

6. The anode of claim 4 wherein:
said nano-fibres were subject to vacuum at a heat temperature temperature of from 45° to 80° C. for a period of from 2 to 8 hours after mixing with said spherical graphite.

7. The anode of claim 6 wherein:
said conductive substrate is copper foil.

8. In a non-aqueous lithium battery having an anode of a conductive substrate coated with a pressed compact of spherical graphite and an ion conducting polymeric binder, the improvement comprising:
the inclusion of up to from 1.5 to 15% by weight of carbon nano-fibres in said pressed compact.

9. The lithium battery of claim 8 wherein:
said spherical graphite is meso-phase carbon micro-balls;
said carbon nano-fibres have an average diameter of about 200 nm, a length of from 10 to 20 μm and an inner core diameter of 65 to 70 nm.

10. The lithium battery of claim 9 wherein:
said carbon nano-fibres are included in an amount of from 2% to 9% by weight.

11. The lithium battery of claim 10 wherein:
said carbon nano-fibres are pretreated vapour grown carbon fibres.

12. The lithium battery of claim 11 wherein:
said nano-fibres were subject to vacuum at heat treating temperatures of from 40° C. to 140° C. prior to mixing with said spherical graphite.

13. The lithium battery of claim 12 wherein:
said nano-fibres were subject to vacuum at heat treating temperatures of from 45° C. to 80° C. after mixing with said spherical graphite.

14. The lithium battery of claim 11 wherein:
said conductive substrate is copper foil.

15. The anode of claim 5 wherein:
said vacuum is from 1 torr (1 mm of Hg) to 10 torr (10 mm of Hg).

16. The lithium battery of claim 11 wherein:
said vacuum is from 1 torr (1 mm of Hg) to 10 torr (10 mm of Hg).

17. The anode of claim 6 wherein:
said vacuum is about 1 torr (1 mm of Hg).

18. The lithium battery of claim 12 wherein:
said vacuum is about 1 torr (1 mm of Hg).

19. A rechargeable lithium battery having an anode containing graphite as an electro-active component and wherein:
said graphite comprises from about 1.5 to 15 weight % carbon nano-fibrils.
